(19) United States
(12) Patent Application Publication
(10) Pub. No.: US 2026/0187681 A1
(43) Pub. Date: Jul. 2, 2026

(54) KEYPHRASE RELEVANCE MODEL ALIGNED WITH SEARCH RELEVANCE DATA TO MITIGATE MIDDLEMAN BIAS

(71) Applicant: eBay Inc., San Jose, CA (US)

(72) Inventors: Soumik DEY, San Jose, CA (US); Julie Wan-Chi CHENG, Los Gatos, CA (US); Wei ZHANG, Shanghai (CN); Hansi WU, Cupertino, CA (US); Binbin LI, Cupertino, CA (US); Bingfeng DONG, Shanghai (CN)

(21) Appl. No.: 19/003,550

(22) Filed: Dec. 27, 2024

(51) Int. Cl. G06Q 30/0241; G06N 3/0455

(52) U.S. Cl. CPC G06Q 30/0276; G06N 3/0455

(57) ABSTRACT

Some aspects relate to technologies for a keyphrase relevance model trained to filter keyphrases when providing relevant keyphrase recommendations for promoted placement of item listings. In accordance with some aspects, a training dataset is accessed. The training dataset comprises training samples that each includes: a keyphrase, item listing data for an item listing on a listing platform, and a label indicating relevance of the keyphrase to the item listing. The relevance labels are obtained using a search relevance model of a search system for the listing platform. Positive training samples have a relevant label, while negative training samples have a non-relevant label. A keyphrase relevance model is trained using the positive training samples and the negative training samples to provide a trained keyphrase relevance model. The trained keyphrase relevance model is used to filter candidate keyphrases in order to provide keyphrase recommendations for item listings on the listing platform.

### BACKGROUND

Listing platforms, such as e-commerce websites, are online platforms that offer items (e.g., products) to users by providing user interfaces to user devices to allow users to find item listings for items to purchase. Such platforms typically offer a vast number of item listings, with each item listing offering a particular item for sale. While some item listings are relevant to any given user, the majority is not. Given the vast number of item listings available, listing platforms include item retrieval functionality, such as search and recommendation, to assist users in finding item listings of interest on the platforms. Some listing platforms also provide for promoted placement of item listings in search and recommendation based on keyphrase bids from sellers.

### SUMMARY

Some aspects of the present technology relate to, among other things, a listing platform that employs a keyphrase relevance model that is trained to filter keyphrases when keyphrase recommendations are being provided to sellers for promoted placement of their item listings on the listing platform. In accordance with some aspects, a training dataset is accessed that includes both positive training samples and negative training samples obtained using search relevance data. Each training sample includes a keyphrase-item listing pair and a relevance label identifying the keyphrase and item listing from the pair as relevant or non-relevant. In some aspects, the training samples are generated using the relevance determination for keyphrase-item listing pairs from a search relevance model of a search system for the listing platform.

The keyphrase relevance model is trained on the training dataset to provide a trained keyphrase relevance model. The training can include providing keyphrase-item listing pairs as input to the keyphrase relevance model, which generates a relevance output for each pair. One or more losses are determined using the relevance output and the label for each pair, and parameters (e.g., weights) of the keyphrase relevance model are updated based on the loss(es). The trained keyphrase relevance model is used to filter candidate keyphrases in order to provide keyphrase recommendations for item listings on the listing platform

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram illustrating an example architecture for a keyphrase relevance model in accordance with some implementations of the present disclosure;

FIG. 3 is a block diagram illustrating another example architecture for a keyphrase model in accordance with some implementations of the present disclosure;

FIG. 4 is a flow diagram showing a method for training a keyphrase relevance model in accordance with some implementations of the present disclosure;

FIG. 5 is a flow diagram showing a method for employing a trained keyphrase relevance model to filter keyphrases when providing keyphrase recommendations for a target item listing in accordance with some implementations of the present disclosure; and

FIG. 6 is a block diagram of an exemplary computing environment suitable for use in implementations of the present disclosure.

### DETAILED DESCRIPTION

### Overview

One challenge for listing platforms is that item listings having low organic search placement in search results or recommendations are rarely, or even never, viewed by users. To trump low organic search placement, listing platforms provide mechanisms for sellers to pay to have item listings presented more prominently in search results or recommendations, such as being listed at the top of a search results page. This is referred to herein as promoted placement of item listings (also referred to as paid placement, preferred placement, sponsored listing, etc.). Keyphrases (sometimes referred to as advertisement keyphrases) are the foundation of promoted placement. The term “keyphrase” is used herein broadly to include not only a series of multiple tokens but also a single token (e.g., a keyword). Sellers select specific keyphrases for their item listings and bid on these keyphrases. During item retrieval tasks, listing platforms employ algorithms that evaluate factors, including bid amounts on keyphrases, to select item listings for promoted placement. This ensures the relevance of the item listings selected for promoted placement. In the context of promoted placement, sellers can be considered advertisers, and the promoted placement of their item listings can be considered advertisements.

To assist sellers in the promoted placement of item listings, listing platforms often provide keyphrase recommendations (sometimes referred to as advertisement keyphrase recommendations) to sellers based on their inventory of item listings. The keyphrase recommendations provided by a listing platform for a given item listing needs to be relevant to the item offered by that item listing; otherwise, it will lead to inefficient targeting that defeats the purpose of the promoted placement. In an attempt to provide relevant keyphrase recommendations for item listings, listing platforms typically include a keyphrase relevance model (sometimes referred to as an advertisement keyphrase relevance model) that filters candidate keyphrases that are deemed not to be relevant to the item listings. For instance, a listing platform could use a keyphrase recommendation pipeline that involves three primary steps: (1) retrieval in which candidate keyphrases for a target item listing are identified; (2) relevance in which candidate keyphrases that are deemed non-relevant to the target item listing are filtered; and (3) and ranking in which typically more sophisticated algorithms are employed to rank the remaining keyphrases for selecting/ordering keyphrase recommendations for presentation.

Keyphrase relevance helps prevent item retrieval systems (e.g., search and recommendation systems) of listing platforms from being inundated with numerous non-relevant item listings for promoted placement, which leads to inefficient computer resource consumption for the server systems performing item retrieval tasks that involve promoted placement. As such, a technical challenge for listing platforms is designing keyphrase relevance models that accurately identify and filter non-relevant keyphrases when recommending keyphrases for item listings.

Conventionally, keyphrase relevance models used for keyphrase recommendation on listing platforms comprise machine learning models trained on historical search data from searches performed on the listing platform. This can include, for instance, click data and sales data. Click data identifies which search queries led to which item listings being selected (i.e., “clicked”) from search results returned for the search queries. Sales data identifies which search queries led to which items being purchased. However, training keyphrase relevance models on historical search data, such as click data and sales data, suffers from a number of shortcomings.

A search query that has garnered a sufficient number of clicks or sales in relation to an item listing in historical search data can be considered a relevant keyphrase for that item. Essentially, clicks and sales are used as strong positive indicators of relevance when training a keyphrase relevance model. However, clicks and sales do not serve well as indicators of non-relevance. Search data from listing platforms suffer from missing-not-at-random (MNAR) conditions due to several biases. An item listing lacking clicks or sales for a particular search query does not necessarily mean that the search query is non-relevant to the item listing. In the context of listing platforms, buyers act as annotators via their clicks/purchases; but unlike typical annotators, buyers see a skewed presentation of item listings influenced by search ranking, which in turn affects their annotations (clicks/purchases). An unpopular item listing will have a poor position on the search results page due to rankings being based on clicks and/or purchases and subsequently may not obtain any clicks or sales. This bias results in the unreliability of negative relevance signals based on clicks or sales.

Search systems of listing platforms provide search results identifying item listings in response to buyer search queries. The search systems often use a search pipeline that also involves three primary steps: (1) retrieval in which candidate item listings are identified for a search query; (2) relevance that typically involves more complex filtering techniques to identify and filter certain candidate item listings to ensure conformity to the search query; and (3) ranking in which the remaining item listings after relevance filtering are ranked for selecting/ordering item listings for presentation. With promoted placement, from a seller's perspective, keyphrases are recommended by a keyphrase recommendation system of the listing platform, and the sellers choose to bid on certain recommended keyphrases for their item listings. These item listings then enter an auction corresponding to the keyphrases. This auction process involves a complex interaction with search, in which the search system acts as a middleman and aligns the auction item listings with the search queries (which can the exact keyphrases recommended by the keyphrase recommendation system) and further filters the auction item listings using a search relevance filter. This auction mechanism also ensures that the click data logged will only contain keyphrases which pass the search relevance filter (i.e., only auction-winning, impression-gaining keyphrases are logged). This introduces an additional bias-training of the keyphrase relevance model is only on keyphrases which pass the search relevance filter. Training on click data ensures that the keyphrase relevance model never experiences keyphrases that are irrelevant to search, while keyphrase recommendation does generate such keyphrases and needs to filter them. This bias is referred to herein as middleman bias, which the click data additionally suffers from in the context of keyphrase recommendation.

A variety of different techniques have been employed to improve keyphrase relevance models for keyphrase recommendation. For example, one approach employed a BERT (bidirectional encoder representations from transformers) model trained on a training dataset generated from human judgement. However, this resulted in irrelevant keyphrases due to a large number of item categories on the listing platform with some categories having inadequate representation in the dataset. In addition, the training dataset suffered from low agreement between the annotators. Another approach involved an XGBoost-based (extreme gradient boosting) CTR (click-through rate) model trained on click data. However, offline evaluation of the CTR model failed in terms of search alignment and spot-checked human judgement. An alternate keyphrase relevance model based on the Jaccard filter provided somewhat better performance. The Jaccard filter used a simple rule-driven token-based algorithm with a threshold to filter out irrelevant keyphrases. However, the Jaccard filter presents its own problems. When using item titles that are generally longer than keyphrases, it heavily penalizes shorter keyphrases-which are generally head keyphrases (head keyphrases are keyphrases which drive most clicks/sales). The introduction of the Jaccard filter essentially eliminated single-token keyphrases. Additionally, since the Jaccard filter is not semantically aware, the Jaccard filter misses targeting opportunities on those keyphrases semantically aligned with the item listing.

Aspects of the technology described herein improve the functioning of server systems for listing platforms that involve keyphrase recommendations for promoted placement of item listings during item retrieval. In some aspects, a keyphrase recommendation system on a listing platform employs a keyphrase relevance model for keyphrase filtering that is trained using positive training samples and negative training samples obtained from the search logs containing the search relevance pass/fail signals The keyphrase relevance model using the technology described herein provides improved performance over conventional keyphrase relevance models, thereby optimizing relevance of item listings selected for promoted placement during item retrieval.

The keyphrase relevance model described herein can be implemented using different neural network architectures. For instance, one architecture employs bi-encoders, where item listing data and keyphrases are encoded independently to generate separate embeddings. These embeddings are then processed by a classifier to determine the relevance of the keyphrases to the item listings. Another architecture uses cross-encoders, which encode the item listing data and keyphrases together as a single embedding, allowing for direct modeling of interactions between them. Cross-encoders typically offer higher accuracy but are more computationally intensive compared to bi-encoders.

The training dataset used to train the keyphrase relevance model includes both positive training samples and negative training samples. Positive training samples are pairs of keyphrases and item listings labeled as relevant, while negative training samples are pairs of keyphrases and item listings labeled as non-relevant.

In some aspects, the training dataset is obtained using the search relevance model from the search system of the listing platform. As noted above, the search relevance model of a search system is used to filter item listings when identifying item listings to return as search results to search queries. Pairs of keyphrases (which can be search queries processed by the search relevance model) and item listings that the search relevance model identifies are relevant are given a relevant label to provide the positive training samples; while pairs of keyphrases and item listings that the search relevance model identifies as non-relevant are given a non-relevant label to provide the negative training samples.

Training the keyphrase relevance model can involve initializing the keyphrase relevance model (e.g., selecting an architecture, setting initial values for model parameters, and selecting loss functions). The training process includes iteratively providing keyphrase-item listing pairs from training samples as input to the keyphrase relevance model, determining one or more losses based on relevance outputs from the keyphrase relevance model and relevance labels from the training samples, and updating model parameters (e.g., weights) based on the loss(es) via backpropagation.

The trained keyphrase relevance model is used to filter keyphrases when the system is identifying relevant keyphrase recommendations for target item listings. Given a target item listing, item listing data for the target item is accessed and used to retrieve a set of candidate keyphrases. Each candidate keyphrase and the item listing data are provided as inputs to the trained keyphrase relevance model, which generates a relevance output for each candidate keyphrase. The candidate keyphrases are filtered based on the relevance outputs, and the remaining keyphrases are ranked. One or more keyphrase recommendations for the target item listing are then provided based on the ranking.

Aspects of the technology described herein provide a number of improvements over existing technologies. For instance, the technology described herein provides a keyphrase relevance model that provides improved performance, for instance, in terms of precision and recall, over conventional keyphrase relevance models. Precision refers to the ratio of keyphrases that pass the keyphrase relevance filter to keyphrases that also pass the search relevance filter. Recall indicates the ratio of keyphrases that pass both the search relevance filter and the advertisement keyphrase relevance filter to the keyphrases that would pass the search relevance filter. While precision is the measure of how aligned the keyphrase relevance filter is with the search relevance filter, recall measures the lost opportunity in terms of targeting potential of keyphrases unnecessarily filtered out. In accordance with some aspects, the trained keyphrase relevance model decreases the false positives (i.e., search irrelevant keyphrases that passed the advertisement keyphrase relevance filter) and also the false negatives (i.e., search relevant keyphrases that were filtered out) while increasing the true positives (search relevant keyphrases that pass the keyphrase relevance filter). By training on both positive training samples and negative training samples based on the search relevance model's judgement, the keyphrase relevance model does not suffer from the same biases as conventional keyphrase relevance models trained on click data or purchase data, while at the same time ensuring that that the keyphrase relevance model is aligned with search relevance for the most optimal outcomes in promoted placement auctions for recommended keyphrases.

### Example System for Keyphrase Recommendation

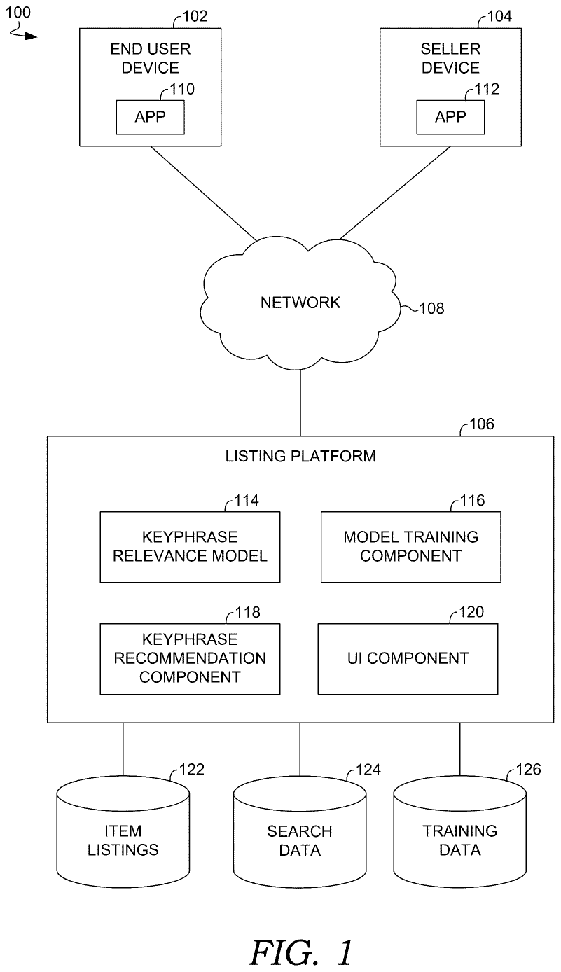

With reference now to the drawings, FIG. 1 is a block diagram illustrating an exemplary system 100 for keyphrase recommendation based on a keyphrase relevance model trained on positive training samples and negative training samples from search relevance in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

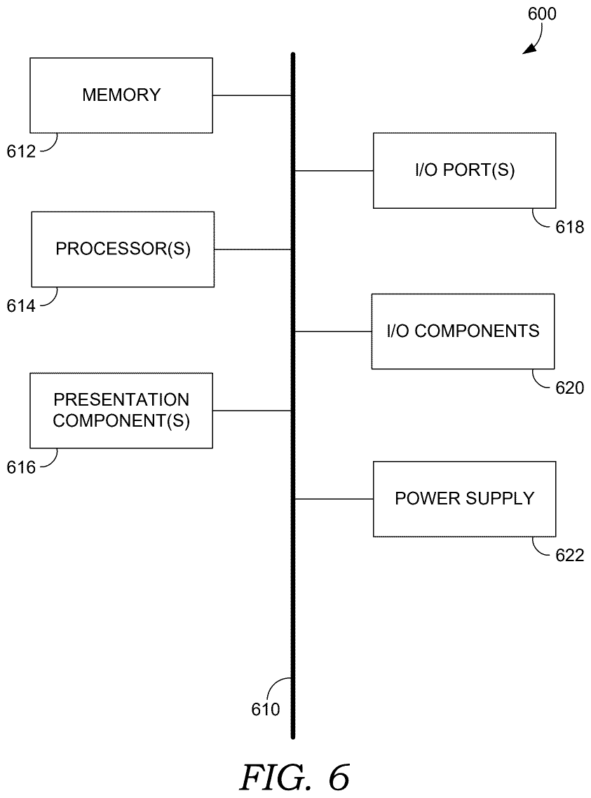

The system 100 is an example of a suitable architecture for implementing certain aspects of the present disclosure. Among other components not shown, the system 100 includes an end user device 102, a seller device 104, and a listing platform 106. Each of the end user device 102, the seller device 104, and the listing platform 106 shown in FIG. 1 can comprise one or more computer devices, such as the computing device 600 of FIG. 6, discussed below. As shown in FIG. 1, the end user device 102, the seller device 104, and the listing platform 106 can communicate via a network 108, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the listing platform 106 could be provided by multiple server devices collectively providing the functionality of the listing platform 106 as described herein. Additionally, other components not shown may also be included within the network environment.

The end user device 102 and the seller device 104 can each be a client device on the client-side of the system 100, while the listing platform 106 can be on the server-side of the system 100. The listing platform 106 can comprise server-side software designed to work in conjunction with client-side software on the end user device 102 and the seller device 104 so as to implement any combination of the features and functionalities discussed in the present disclosure. For instance, the end user device 102 can include an application 110 and the seller device 104 can have an application 112 for interacting with the listing platform 106. The application 110 and the application 112 can each be, for instance, a web browser or a dedicated application for providing functions, such as those described herein. This division of the system 100 is provided to illustrate one example of a suitable environment, and there is no requirement for each implementation that any combination of the end user device 102, the seller device 104, and/or the listing platform 106 remain as separate entities. While the system 100 illustrates a configuration in a networked environment with a separate end user device, seller device, and listing platform, it should be understood that other configurations can be employed in which aspects of the various components are combined. For instance, in some aspects, aspects of the listing platform 106 can be implemented in part or in whole by the end user device 102 and/or the seller device 104.

The end user device 102 and the seller device 104 can each comprise any type of computing device capable of use by a user. For example, in one aspect, the end user device 102 and the seller device 104 may each be the type of computing device 600 described in relation to FIG. 6 herein. By way of example and not limitation, the end user device 102 and the seller device 104 can each be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. An end user (e.g. a buyer user) can be associated with the end user device 102 and can interact with the listing platform 106 via the end user device 102 using the application 110. A seller user can be associated with the seller device 104 and can interact with the listing platform 106 via the seller device 104 using the application 112.

As shown in FIG. 1, the listing platform 106 includes a keyphrase relevance model 114, a model training component 116, a keyphrase recommendation component 118, a user interface component 120. The components of the listing platform 106 may be in addition to other components that provide further additional functions beyond the features described herein. The listing platform 106 can be implemented using one or more server devices, one or more platforms with corresponding application programming interfaces, cloud infrastructure, and the like. While the listing platform 106 is shown separate from the end user device 102 and the seller device 104 in the configuration of FIG. 1, it should be understood that in other configurations, some or all of the functions of the listing platform 106 can be provided on the end user device 102 and/or the seller device 104. Additionally, in some configurations, one or more of the components of the listing platform 106 shown in FIG. 1 can be provided by the end user device 102, the seller device 104, and/or another location not shown in FIG. 1. The components can be provided by a single entity or multiple entities.

In some aspects, the functions performed by components of the listing platform 106 are associated with one or more applications, services, or routines. In particular, such applications, services, or routines may operate on one or more user devices, servers, may be distributed across one or more user devices and servers, or be implemented in the cloud. Moreover, in some aspects, these components of the listing platform 106 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The listing platform 106 generally provides, to end user devices such as the end user device 102, item listings describing items available for purchase or rent using the listing platform 106. For instance, the listing platform 106 could comprise an e-commerce platform, in which listed products are available for purchase by users of user devices upon navigation to a website of the listing platform 106. As other examples, the listing platform 106 could comprise a rental platform listing various items for rent (e.g., equipment, tools, real estate, vehicles, contract employees) or a media platform listing digital content items (e.g., digital content for streaming/download).

The functionality of the listing platform 106 includes provision of interfaces (e.g., via the user interface component 120) to end user devices, such as the end user device 102, enabling surfacing of item listings for items to end users of the listing platform 106. Item listings for items available for sale or rent via the listing platform 106 are stored by the item listings data store 122. Each item listing can include a description relating to an item comprising one or more of a price in a currency, reviews, images of the item, shipment options, a rating, a condition of the item, a size of the item, a color of the item, etc. In aspects, each item listing is also associated with one or more item categories from a pre-defined category hierarchy for the listing platform 106, including meta-categories and leaf categories. For example, the meta-categories are each divisible into subcategories (or branch categories), whereas leaf categories are not divisible.

The functionality of the listing platform 106 also includes provision of interfaces (e.g., via the user interface component 120) to seller devices, such as the seller device 104, enabling a variety of seller-related functions, such as inventory management, order processing, and payment handling. Relevant to the present technology, the listing platform 106 provides keyphrase recommendations to seller users based on their item listings to facilitate the seller users in selecting certain keyphrases for each item listing.

The listing platform 106 trains a keyphrase relevance model 114 (via the model training component 116) and uses the trained keyphrase relevance model 114 to filter keyphrases when performing keyphrase recommendation (via the keyphrase recommendation component 118). The keyphrase relevance model 114 comprises one or more neural networks (i.e., artificial neural networks) that, given a keyphrase and item listing data for an item listing, generates a relevance output providing an indication of relevance of the keyphrase to the item listing. As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In accordance with aspects of the present technology, the keyphrase relevance model 114 comprises an encoder component (also referred to herein as an encoder) and a classifier component (also referred to herein as a classifier). The encoder component comprises one or more encoding layers that, given input including a keyphrase and item listing data, generate one or more embeddings. The input item listing data for an item listing can include any text from the item listing, such as the item title, item category, and/or item description. The classifier component comprises one or more classification layers that take the one or more embeddings as input and generates a relevance output providing an indication of relevance of the keyphrase to the item listing.

The encoder component of the keyphrase relevance model 114 comprises a neural network architecture that extracts features representing the input item listing data and input keyphrase in a compressed, meaningful way to generate one or more embeddings. A variety of different network architectures can be employed for the encoder component. By way of example only and not limitation, the encoder component can employ transformer-based architectures or recurrent neural networks (RNNs) and their variants like long short-term memory (LSTM). In some aspects, the encoder component can comprise a language model that includes a set of statistical or probabilistic functions to perform natural language processing (NLP) in order to understand human natural language text. A language model is called a large language model (LLM) when it comprises a deep neural network that is trained on enormous amounts of data and/or has a large number of parameters.

In some aspects, the encoder component comprises bi-encoders that encode item listing data and a keyphrase independently to generate separate embeddings—i.e., an item listing embedding is generated from the item listing data by an item listing encoder, and a keyphrase embedding is generated from the keyphrase by a keyphrase encoder. In other aspects, the encoder component comprises a cross-encoder that encodes the item listing data and the keyphrase as a single embedding. A cross-encoder processes the two text inputs together, allowing it to directly model interactions between them. Relative to bi-encoders, a cross-encoder typically yields higher accuracy at the expense of being more computationally intensive and increased latency. While bi-encoders and cross-encoders are provided as examples herein, it should be understood that other types of encoders (e.g., poly-encoders) can be employed.

The classifier component of the keyphrase relevance model 114 comprises a neural network architecture that takes the embedding(s) from the encoder component as input and generates a relevance output indicating relevance of the keyphrase to the item listing. This is sometimes referred to as a classification head. A variety of different network architectures can be employed for the classifier component. By way of example only and not limitation, the classifier component can employ transformer-based architectures, RNNs and their variants like LSTM, feed-forward networks (FFNNs), cosine similarity (or other similarity metrics), sigmoid activation functions, and softmax activation functions. The architecture of the classifier component can be dependent on the architecture of the encoder component. For instance, if bi-encoders are employed, the classifier component could simply use similarity metrics such as cosine similarity between the two embeddings to determine relevance. In some aspects, the relevance output of the classifier component of the keyphrase relevance model 114 is a binary classification indicating the keyphrase as relevant (e.g., 1 value) or non-relevant (e.g., 0 value) to the item listing. In other aspects, the relevance output of the classifier component of the keyphrase relevance model 114 is a relevance score (e.g., continuous value from 0 to 1 or some other scale), which can be used by a downstream component to identify the keyphrase as relevant or non-relevant to the item listing (e.g., by comparison to a threshold value).

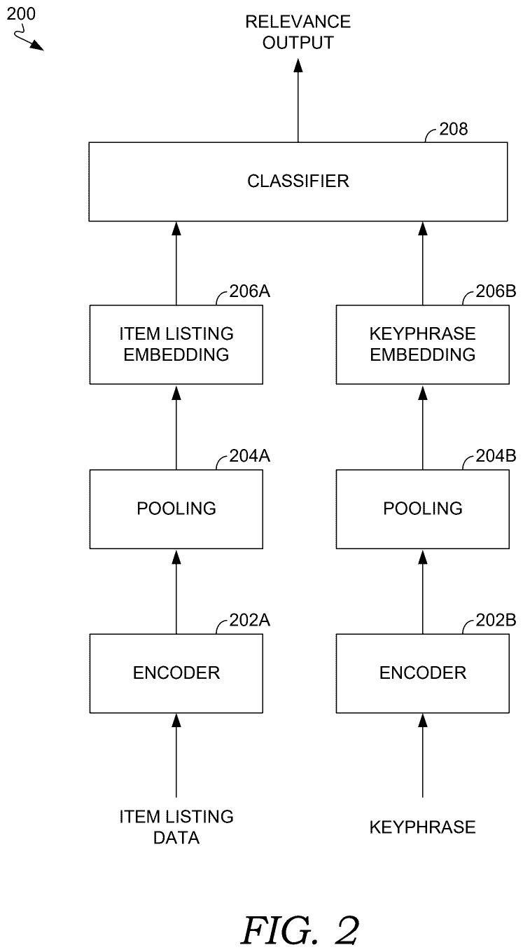

FIG. 2 provides a block diagram showing an example architecture for a keyphrase relevance model 200 in accordance with some aspects of the technology described herein. In particular, the architecture of the keyphrase relevance model 200, employs a bi-encoder architecture. As shown in FIG. 2, item listing data for an item listing is provided as input to an encoder 202A, which is followed by a pooling layer 204A to provide an item listing embedding 206A. Similarly, a keyphrase is provided as input to an encoder 202B, which is followed by a pooling layer 204B to provide a keyphrase embedding 206B. The item listing embedding 206A and the keyphrase embedding 206B are provided as input to a classifier 208. The classifier 208 processes the item listing embedding 206A and the keyphrase embedding 206B to generate a relevance output, which can be a binary indication of relevant or non-relevant or can be a relevance score (e.g., a continuous value).

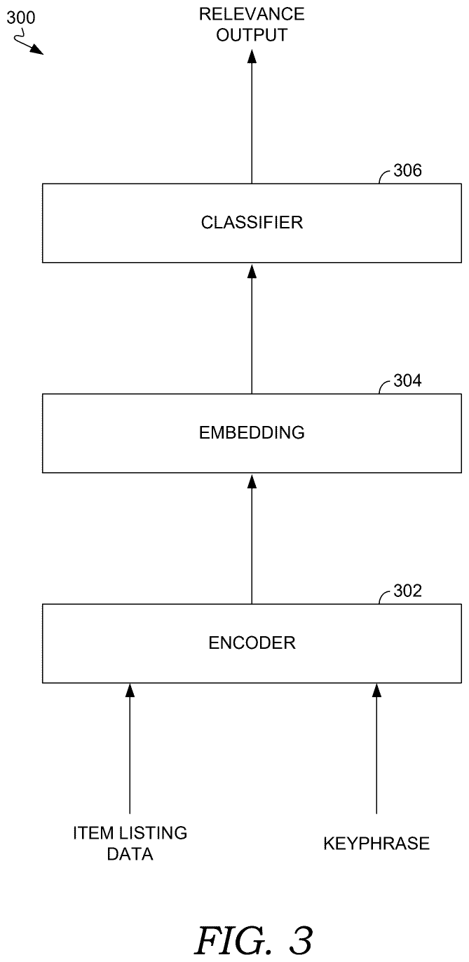

FIG. 3 provides a block diagram showing another example architecture for a keyphrase relevance model 300 in accordance with some aspects of the technology described herein. In particular, the architecture of the keyphrase relevance model 300 employs a cross-encoder architecture. As shown in FIG. 3, item listing data and a keyphrase are provided as input to an encoder 302, which provides a combined embedding 304. While FIG. 3 shows the item listing data and keyphrase as separate inputs to the encoder 302, in some aspects the item listing data and keyphrase are merged (e.g., concatenated) before being input to the encoder 302. The combined embedding 304 is provided as input to a classifier 306. The classifier 306 processes the combined embedding 304 to generate a relevance output, which can be a binary indication of relevant or non-relevant or can be a relevance score (e.g., a continuous value).

With reference again to FIG. 1, the model training component 116 of the listing platform 106 facilitates training the keyphrase relevance model 114 using labeled training data from a training data store 126. In accordance with some aspects, the training data comprises training samples, where each training sample can include three data portions: (1) item listing data for an item listing; (2) a keyphrase; and (3) a label providing an indication of relevance of the keyphrase to the item listing (e.g., 0 value if the keyphrase is non-relevant to the item listing; or 1 value if the keyphrase is relevant to the item listing). As such, each training sample with a relevant label provides a positive training sample, while each training sample with a non-relevant label provides a negative training sample.

In some aspects, the training data is obtained using a search relevance model (not shown) of the listing platform 106. More particularly, the listing platform 106 provides search functions in which search queries from end user devices, such as the end user device 102, are processed in a search pipeline to identify relevant item listings that are returned as search results to the end user devices. The search pipeline of the listing platform 106 employs a search relevance model that, when given a set of candidate item listings for a given search query, identifies each candidate item listing as relevant or non-relevant in order to filter the non-relevant candidate item listings. As such, the search relevance model is specifically designed to provide data indicative of relevance or non-relevance for a given item listing and a given search query. Accordingly, some configurations employ the search relevance model to provide training data to train the keyphrase relevance model. Each training sample in the training data includes item listing data for an item listing paired with a keyphrase and a relevant label (e.g., 1 value) or a non-relevant label (e.g., 0 value) for the pair based on the output of the search relevance model for the item listing and keyphrase (where the keyphrase can be a search query).

In some aspects, the training data obtained using the search relevance model can include additional samples, such as samples obtained from historical search data for the listing platform 106, which is stored in a search data store 124. Search data (e.g., click data and/or sales data) comprises information regarding which search queries resulted in which item listings being selected from search results (i.e., clicked) and/or purchased. The search data provides positive samples between pairs of search queries and item listings clicked and/or purchased in response to the search queries. However, the search data does not provide negative samples. As such, in some configurations, the listing platform 106 employs in-batch random negative sampling (IRNS) to provide negative training samples based on the search data. Using IRNS, given a batch of search data identifying search queries and corresponding clicked/purchased item listings, search queries in the batch are randomly paired with item listings from the batch that were not clicked/purchased for the search queries in the batch of search data. This creates pairs of search queries and item listings that serve as negative training samples. Accordingly, in some aspects, IRNS can be used in conjunction with employing a search relevance model to provide the positive training samples and negative training samples.

As previously indicated, the keyphrase relevance model 114 comprises one or more neural networks. In some aspects, the model architecture of the keyphrase relevance model 114 is built and trained from scratch; while in other aspects, one or more pre-trained models are selected, configured, and fine-tuned. In some aspects, the keyphrase relevance model 114 can be initialized by setting initial values for model parameters (e.g., weights), selecting loss function(s) for training, and setting hyperparameters for training the model, such as, for instance, regularization parameters, model parameters (e.g., a number of layers in a neural network), learning rate, batch sizes selected from the training data, and so on.

After initialization, the model training component 116 trains the keyphrase relevance model 114 using training samples from the training data to update parameters (e.g., weights) of the keyphrase relevance model 114. Generally, the training process includes iteratively performing a forward pass in which a training sample (or a batch of training samples) is provided as input to the keyphrase relevance model 114, determining one or more losses, and updating model parameters (e.g., via backpropagation) based on the loss(es).

Depending on the architecture of the keyphrase relevance model, the model training component 116 can use any of a number of different loss functions. By way of example only and not limitation, the model training component can employ contrastive loss, triplet loss, binary cross-entropy loss, and/or hinge loss. Contrastive loss minimizes the distance between item listing embeddings and keyphrase embeddings for positive training samples and maximizes the distance between item listing embeddings and keyphrase embeddings for negative training samples. Triplet loss is similar to contrastive loss, but each training sample includes an anchor (i.e., item listing data for an item listing), a positive keyphrase (relevant for the anchor), and a negative keyphrase (non-relevant for the anchor). The triplet loss ensures that the distance between the anchor embedding and the positive keyphrase embedding is smaller than the distance between the anchor embedding and the negative keyphrase embedding, for instance, by a specified margin. Binary cross-entropy loss measures the difference between the classifier output and the actual label (relevant or non-relevant) for each training sample. Hinge loss can also be used for binary classification tasks by maximizing the margin between positive and negative samples. While binary cross-entropy focuses on minimizing the difference between predicted probabilities and actual labels, hinge loss ensures that the classifier not only makes correct predictions but also does so with a certain level of confidence by maximizing the distance between classes.

A training iteration can include a forward pass in which the model training component 116 provides item listing data and a keyphrase from a training sample as input to the keyphrase relevance model 114, and the keyphrase relevance model 114 uses its one or more encoders to generate one or more embeddings and, in some instances, its classifier to generate a relevance output from the training sample. The model training component 116 determines one or more losses based on the one or more embeddings and/or the relevance output from the forward pass. The model training component 116 then updates model parameters of the keyphrase relevance model 114 based on the loss(es).

In some aspects, the model training component 116 optimizes the keyphrase relevance model 114 using any of a number of different techniques, such as pruning, quantization, knowledge distillation, and low-rank adaptation (LoRA). Implementing these techniques can make the keyphrase relevance model 114 more efficient to reduce computer resource requirements and latency without significantly impacting performance. In some aspects, the keyphrase relevance model 114 is optimized by fine-tuning a smaller pre-trained model intended for environments with restricted computational resources.

Once the keyphrase relevance model 114 has been trained, the keyphrase recommendation component 118 employs the trained keyphrase relevance model 114 to filter keyphrases when selecting relevant keyphrase recommendations for target item listings. In some aspects, given a target item listing, the keyphrase recommendation component 118 initially performs retrieval to identify a set of candidate keyphrases for the target item listings. The keyphrase recommendation component 118 then uses the trained keyphrase relevance model 114 to determine the relevance of each candidate keyphrase to the target listing. For instance, each candidate keyphrase can be provided as input with item listing data for the target item listing, and given each input, the trained keyphrase relevance model 114 generates a relevance output indicative of the relevance of the candidate keyphrase from the given input to the item listing. Based on the relevance output for each candidate keyphrase, the keyphrase recommendation component 118 filters out candidate keyphrases that are found to be non-relevant to the target item listing. This provides a filtered set of keyphrases. The keyphrase recommendation component 118 then ranks the keyphrases from the filtered set of keyphrases using any of a number of different ranking algorithms. A set of keyphrase recommendations is then provided based on the rankings. For instance, the keyphrases can be sorted in the keyphrase recommendations based on the rankings.

The listing platform also includes a user interface component 120 that provides one or more user interfaces for end users and seller users to interact with the listing platform 106. For instance, the user interface component 120 provides one or more user interfaces to end user devices, such as the end user device 102, and seller devices, such as the seller device 104. In some instances, the user interfaces can be presented on the end user device 102 via the application 110 and on the seller device 104 via the application 112, each of which can be a web browser or a dedicated application for interacting with the listing platform 106. Among other things, the user interface component 120 can provide user interfaces to end user devices, such as search result pages, browse node pages, and item pages for item listings. The user interface component can provide user interfaces to seller devices to facilitate management of seller inventories, including providing keyphrase recommendations to seller users based on their item listings and facilitating selection of particular keyphrases for their item listings.

### Example Methods for Keyphrase Recommendation

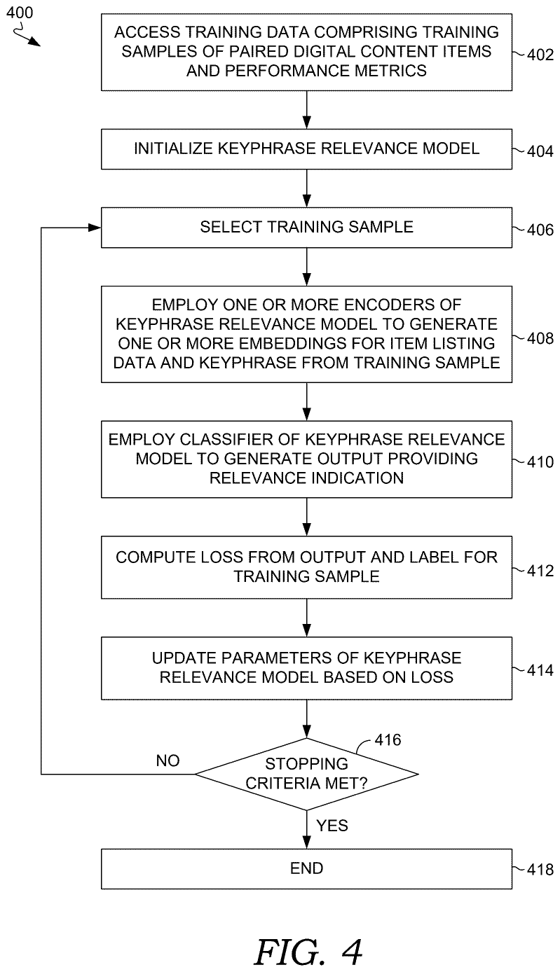

With reference now to FIG. 4, a flow diagram is provided that illustrates a method 400 for training a keyphrase relevance model. The method 400 can be performed, for instance, at least in part by the model training component 116 in order to train the keyphrase relevance model 114 of FIG. 1. Each block of the method 400 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 402, training data is accessed. The training data comprises a number of training samples, where each training sample can include, for instance: (1) item listing data for an item listing; (2) a keyphrase; and (3) a label indicating relevance of the keyphrase to the item listing. Each training sample having a relevant label is considered a positive training sample, while each training sample having a non-relevant label is considered a negative training sample. The item listing data for an item listing comprises text from the item listing, such as an item title, an item description, and an item category for the item listing. The keyphrase comprises one or more tokens.

The positive training samples and the negative training samples in the training data can be obtained using a search relevance model from a search system of the listing platform, which can be supplemented with training samples obtained from historical search data using IRNS. In some aspects, historical search data is available that provides the relevance indication of the search relevance model for search queries and item listings, and that historical search data can be employed to generate the training samples. In other aspects, keyphrase and item listing pairs can be provided to the search relevance model to generate the training samples. In either case, each training sample is generated by pairing a keyphrase (which can comprise a search query from historical search data) with an item listing and labeling the pair with a relevance label based on the relevance indication for the pair from the search relevance model (i.e., a relevant label when the search relevance model provides a relevant indication for the pair and a non-relevant label when the search relevance model provides a non-relevant indication for the pair).

When also using samples obtained from IRNS, historical search data is accessed that identifies search queries and item listing(s) for each search query (e.g., item listing(s) selected as search results and/or that were purchased in response to each search query). Positive training samples are generated from the historical search data by pairing search queries with corresponding item listings from the historical search data. Each pair in the positive training samples is labeled relevant. Negative training samples are generated using IRNS on the historical search data by pairing search queries from the historical search data with item listings from the historical search data where the paired search queries and item listings are not associated with each other in the historical search data. Each pair in the negative training samples is labeled non-relevant.

The keyphrase relevance model is initialized, as shown at block 404. This can include setting up the model's architecture, such as selecting encoder(s) and classifier(s). The initialization process can also include setting initial values for model parameters (e.g., weights), which will be updated during training. The initialization process can further include selecting loss function(s) for training the keyphrase relevance model. Additional hyperparameters for training the model can also be specified, such as, for instance, regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

A training sample is selected from the training data, as shown at block 406. This training sample includes: (1) item listing data for an item listing; (2) a keyphrase; and (3) a label indicating relevance of the keyphrase to the item listing. The selection process may be random or follow a specific sequence, depending on the training strategy employed. Additionally, when batch training is employed, a subset of training samples is selected at block 406, and the following blocks process each training sample from the batch.

As shown at block 408, one or more encoders of the keyphrase relevance model generate one or more embeddings using the item listing data and keyphrase from the selected training sample. In some configurations, bi-encoders are employed in the network architecture of the keyphrase relevance model in which an item listing encoder generates an item listing embedding from the item listing data, and a keyphrase encoder generates a keyphrase embedding from the keyphrase. In other configurations, a cross-encoder is employed in the network architecture of the keyphrase relevance model in which the cross-encoder generates a combined embedding from the item listing and the keyphrase.

As shown at block 410, a classifier of the keyphrase relevance model generates a relevance output using the one or more embeddings generated at block 408. Depending on the network architecture of the keyphrase relevance model, the classifier can be configured to generate a binary relevance output indicating the keyphrase as relevant or non-relevant to the item listing; or the classifier can be configured to generate a relevance output providing a relevance score (e.g., a continuous value) indicative of the relevance of the keyphrase to the item listing.

A loss is computed using the relevance output for the training sample, as shown at block 412. This can involve, for instance, comparing the relevance output with the label from the training sample. As shown at block 414, parameters (e.g., weights) of the keyphrase relevance model are updated based on the loss, for instance, via backpropagation. This can include adjusting the model parameters to minimize the loss, thereby improving the model performance. The update process can use optimization algorithms such as gradient descent.

As shown at block 416, a determination is made as to whether a stopping criterion is met. The stopping criterion can be usable to reduce overfitting of the keyphrase relevance model, reduce computational resource consumption, and/or promote an ability of the keyphrase relevance model to address previously unseen data (i.e., that is not included specifically as an example in the training data). Examples of a stopping criterion include, but are not limited to, a predefined number of epochs, validation loss stabilization, achievement of a performance improvement threshold, whether a threshold level of accuracy has been met, or based on performance metrics such as precision and recall. If the stopping criterion has not been met, the method 400 continues training of the keyphrase relevance model using a new training sample (or batch of training samples), as shown by the return to block 406. If the stopping criterion is met at block 416, the process ends at block 418, for instance by freezing parameters of the keyphrase relevance model. The result is a trained keyphrase relevance model, which can then be used to determine keyphrase relevance for target item listings to filter keyphrases when providing keyphrase recommendations for the target item listings.

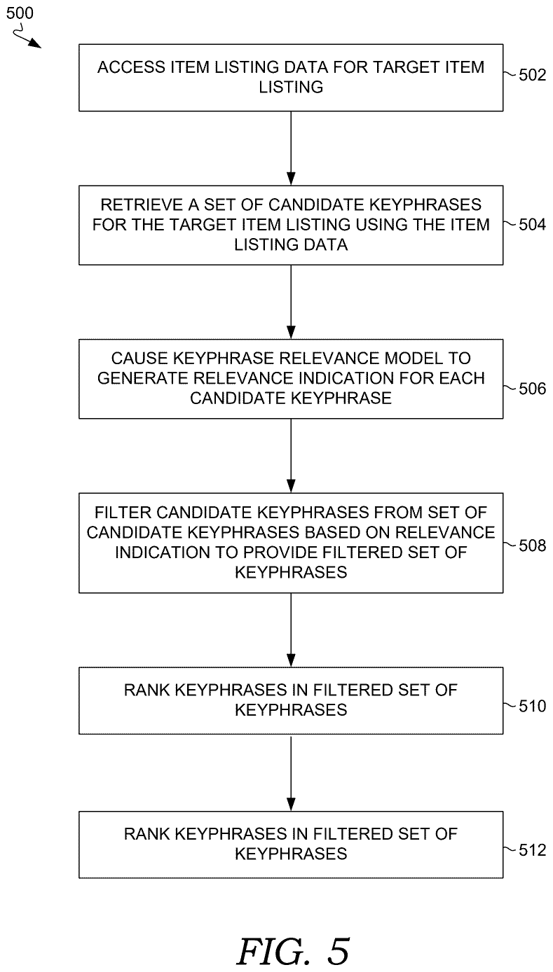

With reference next to FIG. 5, a flow diagram is provided showing a method 500 for employing a trained keyphrase relevance model (e.g., trained using the method 400 of FIG. 4) to provide keyphrase recommendations for a target item listing. The method 500 could be performed, for instance, by the keyphrase recommendation component 118 using the trained keyphrase relevance model 114 of FIG. 1.

As shown at block 502, item listing data for a target item listing is accessed. The item listing data comprises text from the target item listing, such as an item title, an item description, and an item category. The item listing data can be accessed from an item listings data store, such as the item listings data store 122 of FIG. 1. Candidate keyphrases are retrieved using the item listing data, as shown at block 504, to provide a set of candidate keyphrases. This can be done by analyzing the text of the item listing data to identify the candidate keyphrases using a variety of different techniques, such as natural language processing (NLP) and keyphrase extraction algorithms.

The trained keyphrase relevance model is employed to provide an indication of relevance for each candidate keyphrase to the target item listing, as shown at block 506. To determine the relevance for a given candidate keyphrase, the candidate keyphrase and item listing data for the target item listing are provided as input to one or more encoders of the trained keyphrase relevance model, which generates one or more embeddings. The embedding(s) are provided as input to a classifier of the keyphrase relevance model, which generates a relevance output for the candidate keyphrase. In some configurations, the relevance output from the classifier comprises a binary indication of relevance, in which the relevance output indicates the candidate keyphrase as relevant or non-relevant to the target item listing (e.g., a 1 value for relevant or a 0 value for non-relevant). In other configurations, the relevance output from the classifier comprises a relevance score that provides a value indicative of an extent to which the candidate keyphrase is relevant to the target item listing (e.g., a continuous value from 0 to 1 or some other scale).

As shown at block 508, candidate keyphrases are filtered from the set of candidate keyphrases based on the relevance output determined using the keyphrase relevance model for each candidate keyphrase. This provides a filtered set of keyphrases. In configurations in which the keyphrase relevance model generates a relevance output comprising a binary indication of relevance, all candidate keyphrases with a non-relevant output from the keyphrase relevance model are filtered. In configurations in which the keyphrase relevance model generates a relevance output comprising a relevance score, a threshold value could be employed and all candidate keyphrases with a relevance score that does not meet the threshold value are filtered.

The keyphrases in the filtered set of keyphrases are ranked, as shown at block 510. A variety of different ranking algorithms can be employed to perform the ranking. One or more keyphrase recommendations for the target item listing are then provided based on the ranking, as shown at block 512. The keyphrase recommendations can be provided by the listing platform over a network to a seller device of the seller providing the target item listing, thereby allowing the seller to review the keyphrases recommendations and select particular keyphrases for the target item listing based on the keyphrase recommendations.

### Experimental Results

Experiments were conducted to demonstrate the performance improvements provided by keyphrase relevance models using the technology described herein relative to conventional keyphrase relevance models. The experiments involved curating a dataset of 24 million item listing-query pairs for training and 3 million item listing-query pairs for evaluation with labels 1 and 0 indicating the pass/fail from a search relevance model or from IRNS. The item listing data for each item listing in the dataset included the item title and the item category of the item listing. The data was stratified by categories based on activity in terms of traffic. This huge data guaranteed proper representation of all categories while still maintaining preferential bias of models towards high performing categories.

A number of keyphrase relevance models were generated with different architectures, including models using bi-encoders and models using cross-encoders. For bi-encoders, the input format for the item listing data was: item title [SEP] item category name. For cross-encoders, the item listing data and the keyphrase were combined and then consumed by the encoder, using the input format: keyphrase [SEP] item category name [SEP] item title.

For bi-encoders, a pre-trained BERT model was used as the base model with three different techniques taken to provide three bi-encoder models. The first bi-encoder model employed a softmax classifier trained on concatenation and difference of item listing embeddings (u) and keyphrase embeddings (v) (i.e., u, v, |u-v|). The second bi-encoder model employed IRNS based on click data. The third bi-encoder model employed contrastive learning on search relevance labels for the item listing-keyphrase pairs which minimizes the distance between the embeddings for pairs with label 1 and maximizes the distance between the embeddings for pairs with label 0.

For IRNS, an additional dataset was created with 24 million records from 30 days of search activity data with at least one click and with a lower bound of 0.05 CTR and a minimum of 30 impressions for click-based IRNS training. This was to eliminate noisy data points, such as 1 impression, 1 click (accident), or 1000 impressions, 1 click (low CTR), which are misleading. The resulting data points were construed as positive samples, which were then used for deriving negative samples via IRNS.

Since cross-encoders are expensive in terms of inference latency, the experiments used two cross-encoder models of different sizes that provide lower inference latency: a bert-mini model with 4 layers and hidden size of 256; and a bert-tiny model with 2 layers and hidden size of 128.

All models were trained on 4 epochs with a learning rate of 2×10⁻⁵ with 8 A100-80 GB GPUs. The bi-encoder models were trained using a per-device batch size of 384 and fp16 quantization. The bert-mini cross encoder model was trained with a batch size of 10240, while the bert-tiny cross-encoder model was trained with a batch size of 81920. The varying batch sizes for different models were designed to maximize the GPU memory usage for each of the models.

The experiments evaluated each model on the task of aligning with search relevance. Both bi-encoders and cross-encoders have their pros and cons. Bi-encoder representations are generally more scalable as the embedding generation for item listings and keyphrases is done independently. Cross-encoders, on the other hand, can become expensive for inference as it is performed on item listing-keyphrase combinations. However, cross-encoders have a higher performance in terms of natural language understand (NLU) and classification tasks, with the caveat of higher inference latency. For comparison, the scalability of cross-encoder models and test cross-encoders of various sizes was considered to account for their performance in relation to their viability.

Table 1 below presents experimental results of both bi-encoder models and cross-encoder model compared against a conventional Jaccard model. The results are based on the evaluation set of 3 million item listing-keyphrase pairs and their search relevance judgements. The models were evaluated on precision, recall, and F1 scores. In the following, “TP” represents true positive, “FP” represents false positive, and “FN” represents false negative. Precision signifies the ratio of keyphrases that pass the keyphrase relevance filter (TP+FP) to keyphrases that also pass the search relevance filter (TP). Recall indicates the ratio of keyphrases that pass both the search relevance filter and the keyphrase relevance filter (TP) to the keyphrases that would pass the search relevance filter (TP+FN). While precision is the measure of how aligned the keyphrase relevance filter is with the search relevance filter, recall measures the lost opportunity in terms of targeting potential of keyphrases unnecessarily filtered out. The F1scores, which are a harmonic mean of precision and recall, are an indicator for the performance of both.

TABLE 1
Experimental Results

| | | | | | Latency |
|---|---|---|---|---|---|
| | Model | Precision | Recall | F1 | (hrs) |
| Bi-encoders | Softmax | 0.60 | 0.85 | 0.71 | 1 |
| | IRNS | 0.62 | 0.88 | 0.73 | 1 |
| | Contrastive | 0.71 | 0.88 | 0.79 | 1 |
| Cross- | bert-mini | 0.76 | 0.88 | 0.81 | 2.5 |
| encoders | bert-tiny | 0.74 | 0.87 | 0.80 | 1.5 |
| Jaccard | Jaccard | 0.63 | 0.75 | 0.70 | — |

From the results in Table 1, of the bi-encoder models, the contrastive bi-encoder model provided superior F1 scores compared to the softmax bi-encoder model and the IRNS bi-encoder model. Both the contrastive and IRNS bi-encoder models provided very high recall. For cross-encoders, the bert-mini model provided better precision and F1 scores, with a very high recall as well. The smallest model, the bert-tiny model, presented the second highest precision and F1 score of 0.74 and 0.80 respectively. This demonstrated that even the smallest cross-encoders can beat the bi-encoders. The overall performance in terms of F1 scores of all the bi-encoder models and the cross-encoder models was better than the performance of the conventional Jaccard model.

In terms of inference, bi-encoders and cross-encoders have different serving contracts-bi-encoders perform inference for item and keyphrases independently while cross-encoders work on the combination of the two. To gauge inference latency, around 20 million item listings and 3 million keyphrases for bi-encoder models and around 7 billion item listing-keyphrase pairs for cross-encoder models were served using Near-Real-Time (NRT) inference daily. The NRT inference latency for each bi-encoder model for the daily inference was about 1 hour; while the NRT inference latency for the bert-tiny model and the bert-mini model were about 1.5 and 2.5 hours, respectively. These numbers were benchmarked using PySpark inferencing in CPU.

### Exemplary Operating Environment

Having described implementations of the present disclosure, an exemplary operating environment in which embodiments of the present technology may be implemented is described below in order to provide a general context for various aspects of the present disclosure. Referring initially to FIG. 6 in particular, an exemplary operating environment for implementing embodiments of the present technology is shown and designated generally as computing device 600. Computing device 600 is but one example of a suitable computing environment and is not intended to suggest any limitation as to the scope of use or functionality of the technology. Neither should the computing device 600 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 6, computing device 600 includes bus 610 that directly or indirectly couples the following devices: memory 612, one or more processors 614, one or more presentation components 616, input/output (I/O) ports 618, input/output components 620, and illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 600. The computing device 600 may be equipped with depth cameras, such as, stereoscopic camera systems, infrared camera systems, RGB camera systems, and combinations of these for gesture detection and recognition. Additionally, the computing device 600 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
accessing a training dataset, the training dataset comprising a plurality of training samples where each training sample includes a keyphrase, item listing data for an item listing on a listing platform, and a label indicating relevance of the keyphrase to the item listing based on a search relevance model of a search system for the listing platform; and
training a keyphrase relevance model using the training data to provide a trained keyphrase relevance model, the training including, for a first training sample from the plurality of training samples:
causing one or more encoders of the keyphrase relevance model to generate one or more embeddings using a first item listing data and a first keyphrase from the first training sample,
causing a classifier of the keyphrase relevance model to generate a first relevance output using the one or more embeddings,
generating a loss using the first relevance output and a first label from the first training sample, and
updating parameters of the keyphrase relevance model based on the loss.

2. The one or more computer storage media of claim 1, wherein the plurality of training samples in the training dataset comprises a plurality of positive training samples and a plurality of negative training samples identified using the search relevance model of the search system of the listing platform;
wherein a first positive training sample comprises: a first positive keyphrase, an item listing identified as relevant to the first positive keyphrase by the search relevance model, and a relevant label; and
wherein a first negative training sample comprises: a first negative keyphrase, an item listing identified as non-relevant to the first negative keyphrase by the search relevance model, and a non-relevant label.

3. The one or more computer storage media of claim 1, wherein the training dataset comprises a second plurality of training samples, wherein the second plurality of training samples in the training dataset comprises a plurality of positive training samples and a plurality of negative training samples, and wherein accessing the training dataset comprises:
accessing historical search data identifying a plurality of search queries and one or more item listings for each of the plurality of search queries;
generating the plurality of positive training samples using the historical search data, wherein a first positive training sample comprises: a first search query from the plurality of search queries as a first positive keyphrase, an item listing associated with the first search query in the historical search data, and a relevant label; and
generating the plurality of negative training samples using in-batch random negative sampling on the historical search data, wherein a first negative training sample comprises: a second search query from the plurality of search queries as a first negative keyphrase, an item listing from the historical search data not associated with the search query in the historical search data, and a non-relevant label.

4. The one or more computer storage media of claim 1, wherein the one or more encoders comprise an item listing encoder and a keyphrase encoder; and wherein the one or more embeddings comprises an item listing embedding generated by the item listing encoder using the first item listing data and a keyphrase embedding generated by the keyphrase encoder using the first keyphrase.

5. The one or more computer storage media of claim 1, wherein the one or more encoders comprise a cross-encoder; and wherein the one or more embeddings comprise a combined embedding generated by the cross-encoder using the first item listing data and the first keyphrase.

6. The one or more computer storage media of claim 1, wherein the first relevance output from the classifier comprises a binary indication of relevance.

7. The one or more computer storage media of claim 1, wherein the first relevance output from the classifier comprises a relevance score.

8. The one or more computer storage media of claim 1, wherein the operations further comprise:
employing the trained keyphrase relevance model when providing one or more keyphrase recommendations for a target item listing.

9. The one or more computer storage media of claim 8, wherein employing the trained keyphrase relevance model when providing the one or more keyphrase recommendations for the target item listing comprises:
accessing target item listing data for the target item listing;
retrieving a plurality of candidate keyphrases using the target item listing data;
causing the trained keyphrase relevance model to generate a corresponding relevance output for each candidate keyphrase by providing the target item listing data and each candidate keyphrase as paired inputs to the trained keyphrase relevance model;
filtering one or more candidate keyphrases from the plurality of candidate keyphrases based on the corresponding relevance output for each candidate keyphrase to provide a filtered set of keyphrases;
ranking the keyphrases from the filtered set of keyphrases; and
providing the one or more keyphrase recommendations for the target item listing based on the ranking.

10. A computer-implemented method comprising:
accessing a training dataset comprising a plurality of positive training samples and a plurality of negative training samples by:
providing a plurality of keyphrases and item listing data for a plurality of item listings to a search relevance model of a search system of a listing platform,
generating the plurality of positive training samples from pairs of keyphrases and item listings identified as relevant by the search relevance model, and
generating the plurality of negative training samples from pairs of keyphrases and item listings identified as non-relevant by the search relevance model; and
training a keyphrase relevance model using the plurality of positive training samples and the plurality of negative training samples to provide a trained keyphrase relevance model.

11. The computer-implemented method of claim 10, wherein training the keyphrase relevance model comprises:
causing one or more encoders of the keyphrase relevance model to generate one or more corresponding embeddings for each positive training sample and each negative training sample;
causing a classifier of the keyphrase relevance model to generate a corresponding relevance output for each positive training sample and each negative training sample using the corresponding one or more embeddings for each positive training sample and each negative training sample;
generating one or more losses using the corresponding relevance output for each positive training sample and each negative training sample; and
updating parameters of the keyphrase relevance model based on the one or more losses.

12. The computer-implemented method of claim 11, wherein the one or more encoders comprise an item listing encoder that generates a corresponding item listing embedding for each positive training sample and each negative training sample and a keyphrase encoder that generates a corresponding keyphrase embedding for each positive training sample and each negative training sample.

13. The computer-implemented method of claim 11, wherein the one or more encoders comprise a cross-encoder that generates a corresponding combined embedding for each positive training sample and each negative training sample.

14. The computer-implemented method of claim 11, wherein the corresponding relevance output from the classifier for each positive training sample and each negative training sample comprises a binary indication of relevance.

15. The computer-implemented method of claim 11, wherein the corresponding relevance output from the classifier for each positive training sample and each negative training sample comprises a relevance score.

16. The computer-implemented method of claim 11, wherein the method further comprises:
employing the trained keyphrase relevance model when providing one or more keyphrase recommendations for a target item listing.

17. The computer-implemented method of claim 16, wherein employing the trained keyphrase relevance model when providing the one or more keyphrase recommendations for the target item listing comprises:
accessing target item listing data for the target item listing;
retrieving a plurality of candidate keyphrases using the target item listing data;
causing the trained keyphrase relevance model to generate a corresponding relevance output for each candidate keyphrase by providing the target item listing data and each candidate keyphrase as paired inputs to the trained keyphrase relevance model;
filtering one or more candidate keyphrases from the plurality of candidate keyphrases based on the corresponding relevance output for each candidate keyphrase to provide a filtered set of keyphrases;
ranking the keyphrases from the filtered set of keyphrases; and
providing the one or more keyphrase recommendations for the target item listing based on the ranking.

18. A computer system comprising:
a search relevance model of a listing platform that generates an indication of relevance of item listings to search queries submitted to the listing platform;
a keyphrase relevance model comprising one or more neural networks providing one or more encoders and a classifier;
a model training component executed by at least processor from one or more processors that trains the keyphrase relevance model to provide a trained keyphrase relevance model using a plurality of positive training samples and a plurality of negative training samples generated using the search relevance model; and
a keyphrase recommendation component executed by at least one processor from the one or more processors that employs the trained keyphrase relevance model to provide one or more keyphrase recommendations for a target item listing.

19. The computer system of claim 18, wherein the model training component trains the keyphrase relevance model by:
causing the one or more encoders of the keyphrase relevance model to generate one or more corresponding embeddings for each positive training sample and each negative training sample;
causing the classifier of the keyphrase relevance model to generate a corresponding relevance output for each positive training sample and each negative training sample using the corresponding one or more embeddings for each positive training sample and each negative training sample;
generating one or more losses using the corresponding relevance output for each positive training sample and each negative training sample; and
updating parameters of the keyphrase relevance model based on the one or more losses.

20. The computer system of claim 18, wherein the keyphrase recommendation component employs the trained keyphrase relevance model when providing the one or more keyphrase recommendations for the target item listing by:
accessing target item listing data for the target item listing;
retrieving a plurality of candidate keyphrases using the target item listing data;
causing the trained keyphrase relevance model to generate a corresponding relevance output for each candidate keyphrase by providing the target item listing data and each candidate keyphrase as paired inputs to the trained keyphrase relevance model;
filtering one or more candidate keyphrases from the plurality of candidate keyphrases based on the corresponding relevance output for each candidate keyphrase to provide a filtered set of keyphrases;
ranking the keyphrases from the filtered set of keyphrases; and
providing the one or more keyphrase recommendations for the target item listing based on the ranking.
